(19) United States
(12) Patent Application Publication
(10) Pub. No.: US 2009/0030157 A1
(43) Pub. Date: Jan. 29, 2009

(54) Method for the Continuous Production of Mono-, Oligo- and/or Polyborosilazanes that Contain Carbon

(75) Inventors: Martin Jansen, Leonberg (DE); Thomas Jaschke, Stuttgart (DE); John Kahsnitz, Halter am See (DE); Jörg Schmidt, Marl (DE); Norbert Schladerbeck, Kelkheim (DE)

Correspondence Address: SUTHERLAND ASBILL & BRENNAN LLP, 999 PEACHTREE STREET, N.E., ATLANTA, GA, 30309, US

(73) Assignee: MAX-PLANCK-GESELLSCHAFT ZUR FÖRDERUNG DER WISSENSC, Munchen (DE)

(21) Appl. No.: 11/815,636

(22) PCT Filed: Feb. 3, 2006
(86) PCT No.: PCT/EP06/00953

§ 371 Date: Sep. 12, 2008

(30) Foreign Application Priority Data
Feb. 5, 2005 (DE) 10 2005 005 383.1

(51) Int. Cl. C08G 77/56

(52) U.S. Cl. 525/389; 528/5; 422/131

(57) ABSTRACT

The invention relates to a device and a method for producing mono-, oligo- and/or polyborosilazanes that contain carbon. According to said method (i) a one-component precursor compound is reacted with ammonia or an organic amino in an aminolysis step, (ii) a reaction mixture is extracted at least once from the aminolysis in a continuous extraction step using an organic solvent, (iii) ammonia or a phase containing organoamine that accumulates during the extraction process is discarded, recovered or at least partly recirculated and (iv) mono-, oligo- and/or polyborosilazanes containing carbon are obtained from the extraction phase containing the solvent.

The present invention relates to a process for preparing carbon-containing borosilazanes, and apparatus suitable for this purpose, their use and the process product obtained.

Nonoxidic ceramic materials are significantly superior to the present-day, mostly oxidic high-performance ceramics in terms of their heat resistance. Thus, multinary (carbo)nitridic materials retain their good mechanical properties even at high temperatures up to at least 1500° C. The quaternary system Si/B/N/C has hitherto proven to be particularly advantageous (DE 101 04 536 A1, WO 02/22625 A1, U.S. Pat. No. 5,312,942, DE 100 45 428 A1, DE 100 45 427 A1, DE 196 28 448 A1).

The synthesis of Si/B/N/C ceramics is carried out by thermal decomposition (pyrolysis) of appropriate preceramic polymers which can be obtained from molecular precursors by polymerization (polymer route). Homogeneous Si/B/N/C ceramics require the use of single-component precursors. The single-component precursor compounds or preceramic polymers generally comprise all (cationic) elements wanted in the resulting ceramic in one molecule. Preceramic polymers are generally a mixture of carbon-containing monoborosilazanes, oligoborosilazanes and polyborosilazanes (hereinafter also referred to as polyborosilazanes or polymers for short).

To make it possible for the ceramic products obtained in this way to be economically usable for a wider use spectrum, a cost-effective route to the monomeric raw material necessary for this purpose is desirable. In particular, efforts are made to use very inexpensive components as starting materials.

These economic boundary conditions for the raw materials are at present fulfilled by methylchlorosilanes (MCS, ex Müller-Rochow synthesis) and hexamethyldisilazane (HMDS).

The monomeric single-component precursors can be obtained by silazane cleavage of HMDS using various methylchlorosilanes (MCS) and subsequent reaction with boron trichloride (BCl₃). Depending on the MCS raw material used, it is possible to obtain, for example, trichlorosilylaminodichloroborane (TADB) from tetrachlorosilane, methyldichlorosilylaminodichloroborane (MADB) from methyltrichlorosilane or dimethylchlorosilylaminodichloroborane (DADB) from dimethyldichlorosilane.

Subsequent crosslinking of the chlorine-containing monomeric precursors to form the corresponding preceramic polymer is effected by reaction with a nitrogen-containing crosslinking reagent, for example ammonia or a primary amine. To achieve very complete crosslinking with replacement of the chlorine functions of the precursor molecule, the amine is used in a large molar excess. The aminolysis is generally carried out in an inert solvent in which the polymer dissolves so that the ammonium hydrochloride which is likewise formed in the aminolysis can be separated off. Removal of the solvent gives a preceramic polymer which generally still has a significant proportion of chloride.

This polymerization process which has been used hitherto has two critical disadvantages. Despite a multiple excess of ammonia or amine, a preceramic polymer obtained in this way still contains a significant amount of chloride. Furthermore, large amounts of solvent are used up in the synthesis.

It was an object of the present invention to provide a further possible way of preparing preceramic polymer as economically as possible. Particular objectives were to reduce the consumption of solvent and to prepare a product having a very low chloride content.

According to the invention, this object is achieved as set forth in the claims.

It has surprisingly been found that, in the present process, the multiphase nature of the product mixture which occurs from time to time during the aminolysis can advantageously be utilized for separating off the polymer from the ammonium salt, as a result of which a complicated filtration is avoided and the amount of solvent required can be drastically reduced. Thus, the polyborosilazane/solvent phase formed can be continuously separated off from the hydrochloride/amine phase by phase separation and, if appropriate, can be after-treated by after-neutralization and subsequent fine filtration. The hydrochloride/amine phase contains the major part of the hydrochloride formed and can either be discarded or can, if appropriate after suitable treatment, for example with a neutralizing agent, be worked up and recirculated as starting material to the system. As neutralizing agent, it is possible to use, for example, ammonia, alkaline metal alkyls such as methylsodium, alkali metal alkoxides such as sodium methoxide, organic amines, alkali metal hydroxides such as NaOH, KOH, or alkali metal hydrides such as LiH, NaH, LiAlH₄, to name only a few examples. Furthermore, the amine can easily he separated off from the ammonium salt by distillation and be fed as starting material to a new reaction run (aminolysis). Furthermore, the solvent can be separated off continuously from the polyborosilazane/solvent phase (hereinafter also referred to as solvent phase for short) by distillation and advantageously be reused.

The aminolysis can also be carried out without addition of solvent in a stirred vessel. It can be advantageous to take off part of the product mixture continuously, transfer it to an extraction apparatus and replace the portion which has been taken off by corresponding amounts of starting material. In the extraction, an extractant or solvent is added so that the reaction product of the aminolysis of the hydrochloride/amine phase goes into the solvent or extractant phase and the two phases can be separated from one another. The extraction with subsequent distillation of the solvent or extractant phase and recirculation of the solvent or extractant obtained in this way into the system can be carried out continuously and thus particularly economically.

In a further, preferably continuously operated process step of the present process, the chlorine content of the polymer obtained after the distillation can advantageously be reduced further, as a result of which a high purity desirable for further processing to give a polymer can be achieved. Here, the polymer can advantageously be reacted with reactive metal amides, hydrides or metal organyls, e.g. lithium dimethylamide, magnesium bis(dimethylamide), lithium aluminum hydride, methyllithium, dimethylmagnesium, and the residual chlorine functions thus be separated off as metal salts. This after-treatment of the polymer can also advantageously be carried out using secondary amines under superatmospheric pressure.

The present invention therefore provides a process for preparing carbon-containing polyborosilazanes, which comprises
(i) reacting a single-component precursor compound with ammonia or an organic amine in an aminolysis step,
(ii) extracting reaction mixture from the aminolysis at least once with an organic solvent in a continuously operated extraction step,
(iii) discarding, working up or at least partly recirculating ammonia- or organoamine-containing phase obtained in the extraction and
(iv) isolating carbon-containing monoborosilazanes, oligoborosilazanes and/or polyborosilazanes, in particular a mixture of monoborosilazanes, oligoborosilazanes and polyborosilazanes, from the solvent-containing phase from the extraction.

For the purposes of the present invention, single-component precursor compounds are essentially silylaminohaloboranes, silylalkylhaloboranes, silylaminoborazines, silylalkylborazines or mixtures of at least two of the abovementioned compounds.

Step (i) of the process of the invention is preferably carried out using a silylaminohaloborane of the general formula Ia

X_{(3-n)R}ₙSi—(NR¹)—BRₘX′₍₂₋ₘ₎ (Ia)
where groups R are identical or different and R is a linear, branched or cyclic hydrocarbon radical having from 1 to 20 carbon atoms, R¹ is a hydrogen atom or a linear, branched or cyclic hydrocarbon radical having from 1 to 20 carbon atoms, preferably hydrogen or methyl, groups X and X′ are identical or different and X and X′ are each H, F, Cl, Br, I or an alkylamino group such as —NR²₂, where groups R² are identical or different and R² is a hydrogen atom or a linear, branched or cyclic hydrocarbon radical having from 1 to 20 carbon atoms, preferably methyl or methyl together with hydrogen, or an alkoxy group such as —OR³, where R3 is a hydrogen atom or a linear, branched or cyclic hydrocarbon radical having from 1 to 20 carbon atoms, preferably methoxy or ethoxy, and n and m can each be, independently of one another, 0, 1 or 2, preferably n=0, 1 or 2 and m=0 or 1,
   or a silylalkylhaloborane of the general formula Ib

X_{(3-n)R}ₙSi—[C(R⁴)₂]p-BRₘX′₍₂₋ₘ₎ (Ib)
where groups R are identical or different and R is a linear, branched or cyclic hydrocarbon radical having from 1 to 20 carbon atoms, groups R⁴ are each, independently of one another, a hydrogen atom or a linear, branched or cyclic hydrocarbon radical having from 1 to 20 carbon atoms, preferably hydrogen, methyl, ethyl, propyl, butyl, pentyl, or directly adjacent units R⁴ are joined to one another via a covalent bond, p can be 1, 2 or 3, groups X and X′ are identical or different and X and X′ are each H, F, Cl, Br, I or an alkylamino group such as —NR²₂, where groups R² are identical or different and R² is a hydrogen atom or a linear, branched or cyclic hydrocarbon radical having from 1 to 20 carbon atoms, preferably methyl or methyl together with hydrogen, or an alkoxy group such as —OR³, where R³ is a hydrogen atom or a linear, branched or cyclic hydrocarbon radical having from 1 to 20 carbon atoms, preferably methoxy or ethoxy, and n and m can each be, independently of one another, 0, 1 or 2, preferably n=0, 1 or 2 and m=0 or 1,
   or a silylaminoborazine of the general formula Ic

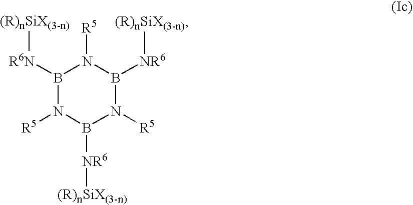

where groups R are identical or different and R is a linear, branched or cyclic hydrocarbon radical having from 1 to 20 carbon atoms, groups R⁵ and R⁶ are identical or different and R5 and R⁶ are each a hydrogen atom or a linear, branched or cyclic hydrocarbon radical having from 1 to 20 carbon atoms, preferably hydrogen or methyl, groups X and X′ are identical or different and X and X′ are each H, Fr Cl, Br, I, preferably Cl, or an alkylamino group such as —NR²₂, where groups R² are identical or different and R² is a hydrogen atom or a linear, branched or cyclic hydrocarbon radical having from 1 to 20 carbon atoms, preferably methyl or methyl together with hydrogen, or an alkoxy group such as —OR³, where R³ is a hydrogen atom or a linear, branched or cyclic hydrocarbon radical having from 1 to 20 carbon atoms, preferably methoxy or ethoxy, and n can be, 0, 1 or 2,
   or a silylalkylborazine of the general formula Id

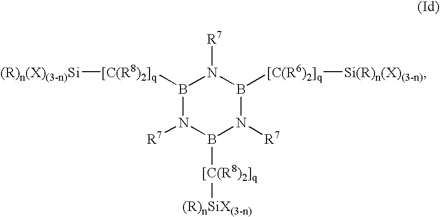

where groups R are identical or different and R is a linear, branched or cyclic hydrocarbon radical having from 1 to 20 carbon atoms, groups R⁷ are each, independently of one another, a hydrogen atom or a linear, branched or cyclic hydrocarbon radical having from 1 to 20 carbon atoms, preferably hydrogen or methyl, groups R⁸ are each, independently of one another, a hydrogen atom or a linear, branched or cyclic hydrocarbon radical having from 1 to 20 carbon atoms, preferably hydrogen, methyl, ethyl, propyl, butyl, pentyl, or directly adjacent units R⁸ are joined to one another via a covalent bond, q can be 1, 2 or 3, groups X are identical or different and X is H, F, Cl, Br, I, preferably Cl, or an alkylamino group such as —NR²₂, where groups R² are identical or different and R² is a hydrogen atom or a linear, branched or cyclic hydrocarbon radical having from 1 to 20 carbon atoms, preferably methyl or methyl together with hydrogen, or an alkoxy group such as —OR³, where R³ is a hydrogen atom or a linear, branched or cyclic hydrocarbon radical having from 1 to 20 carbon atoms, preferably methoxy or ethoxy, and n can independently be 0, 1 or 2,
   or a mixture of at least two compounds of the formulae Ia to Id.

Particular preference is given to a single-component precursor compound according to abovementioned formulae Ia to Id selected from the group consisting of trichlorosilylaminodichloroborane, methyldichlorosilylaminodichloroborane, dimethylchlorosilylaminodichloroborane, trichlorosilylaminochloromethylborane, methyldichlorosilylaminochloromethylborane, dimethylchlorosilylaminochloromethylborane, trichlorosilyldichloroborylmethane, methyldichlorosilyldichloroborylmethane, dimethylchlorosilyldichloroborylmethane, trichlorosilylchloromethylborylmethane, methyldichlorosilylchloromethylborylmethane, dimethylchlorosilylchloromethylborylmethane, B,B′,B″-tristrichlorosilylamino)-borazine, B,B′,B″-tris[dichloro(methyl)silylamino]-borazine, B,B′,B″-tris[dichloro(methyl)silylamino]-borazine, B,B′,B″-tris(trichlorosilylmethyl)borazine, B,B′,B″-tris[dichloro(methyl)silylmethyl]borazine, B,B′,B″-tris[chloro(dimethyl)silylmethyl]borazine or a mixture of at least two of the abovementioned compounds, with the use of methyldichlorosilylaminodichloroborane, trichlorosilylamlnodichloroborane, dichloroborylmethyltrichlorosilylamine, trichlorosilyldichloroborylmethane, methyldichlorosilyldichloroboryl methane, B,B′,B″-tris(trichlorosilylamino)borazine, B,B′,B″-tris[dichloro(methyl)silylamino]borazine, B,B′,B′-tris(trichlorosilylmethyl]borazine or B,B′,B″-tris[dichloro(methyl)silylmethyl]borazine being particularly preferred.

Further preference is given, in step (i), to the use of ammonia or a primary or secondary organoamine of the general formula II

R⁹_{y}NH_{(3-y)} (II),
where groups R⁹ are identical or different and R⁹ is a linear, branched or cyclic hydrocarbon radical having from 1 to 20 carbon atoms and y can be 1 or 2,
   or a mixture of at least two of the abovementioned components. Liquid ammonia or a primary or secondary organoamine selected from the group consisting of methylamine, ethylamine, dimethylamine and diethylamine are particularly suitable, with methylamine being particularly preferably used and a secondary amine in admixture with ammonia and/or a primary amine being advantageous for controlling the degree of crosslinking.

The ammonia or the organoamine is advantageously used in excess in step (i) of the process of the invention. Particular preference is here given to an at least 4- to 8-fold molar excess.

The aminolysis (i) in the process of the invention is appropriately carried out at a temperature in the range from −50 to +80° C. and a pressure of from 0.1 to 20 bar abs. Step (i) is preferably carried out at from −40 to 60° C., particularly preferably from −30 to 30° C., very particularly preferably from −25 to 10° C., in particular from −10 to 10° C., and at a preferred pressure of from 0.5 to 20 bar abs., particularly preferably from 0.8 to 10 bar abs., very particularly preferably from 0.9 to 3 bar abs., in particular at ambient pressure.

Furthermore, the aminolysis (i) in the process of the invention is preferably carried out under reaction conditions under which the reaction mixture is present as a single phase.

Thus, the aminolysis (i) can advantageously be carried out in the presence of a solvent. Here, a substance or a mixture of substances selected from the group consisting of C₃-C₉-hydrocarbons can be used as solvent in the aminolysis (i).

Furthermore, step (i) of the process of the invention can advantageously be carried out continuously, with starting materials being fed to the reaction mixture in an amount corresponding to the amount of reaction mixture being taken off from step (i) and fed to step (ii).

In the extraction (ii) according to the invention, a substance or mixture of substances selected from the group consisting of C₃-C₉-hydrocarbons is appropriately used as extractant or solvent.

Preference is given, in the present process, to using an extractant or solvent selected from the group consisting of n-butane, i-butane, n-pentane, i-pentane, n-hexane, cyclohexane, n-octane, i-octane, petroleum spirit, toluene, xylene and mixtures of at least two of the abovementioned substances. The use of n-hexane, cyclohexane or n-pentane is particularly preferred.

Furthermore, step (ii) of the process of the invention is preferably carried out using solvent or extractant and ammonia or organoamine present in a volume ratio of from 20:1 to 1:20. It is advantageously carried out at a volume ratio of from 10:1 to 1:10, particularly preferably from 8:1 to 1:2, and when hexane and methylamine are used, very particularly preferably in a volume ratio under operating conditions of from 7:1 to 1:1, in particular from 4:1 to 2:1.

Thus, the extraction (ii) in the process of the invention is advantageously carried out at ambient pressure and a temperature in the range from −50° C. to the boiling point of the solvent or extractant or organoamine used, preferably in the range from −20 to about 80° C., with a temperature in the range from −20 to +30° C. being particularly preferred.

In general, the extraction mixture is continuously separated into a solvent- or extractant-containing phase and an ammonia- or organoamine-containing phase in the extraction (ii) according to the invention.

In the process of the invention, the ammonia- or organoamine-containing phase separated off in the preceding extraction stage can be extracted once more with a solvent or extractant in order to recover residual amounts of so-called polyborosilazane still present. Thus, the extraction (ii) according to the invention can comprise from at least one to six, preferably from two to five, particularly preferably from three to four, successive extraction stages.

Furthermore, in step (iii) of the process of the invention, preference is given to at least part of the ammonia- or organoamine-containing phase from the extraction (ii) being recirculated to the aminolysis (i) or the ammonia- or organoamine-containing phase from the extraction (ii) being distilled and the organoamine or ammonia recovered in this way being reused. Thus, the organoamine or the ammonia can advantageously be recycled in the process of the invention, in particular as starting component in the aminolysis or as neutralizing agent in the after-treatment.

Furthermore, in step (iv), the solvent or extractant is, according to the invention, separated off by distillation from the solvent- or extractant-containing phase obtained in step (ii), if appropriate purified and fed back into the aminolysis (i) and/or the extraction (il) and the carbon-containing borosilazane (polymer) obtained is, if appropriate, after-treated.

To carry out the after-treatment in the present process the carbon-containing monoborosilazane, oligoborosilazane and/or polyborosilazane (also referred to as carbon-containing polyborosilazane or polyborosilazane or polymer for short) obtained in step (iv) can, in a step (v), be dissolved in a solvent and a strong base can be added to this solution or, in the sense of step (iv), the solvent or extractant-containing phase from the extraction (ii) to form a (crystalline) chloride under the prevailing conditions and this salt can be separated off from the liquid, solvent- or extractant-containing phase, preferably by filtration or by means of a centrifuge, and the treatment step can be repeated one or more times.

Here, the strong base is preferably ammonia, a primary or secondary organoamine, more preferably an organoamine of the general formula II, in particular methylamine or dimethylamine, a metal amide, preferably lithium dimethylamide, sodium amide, magnesium bis(dimethylamide), a metal hydride, preferably lithium hydride, sodium hydride, aluminum hydride, lithium aluminum hydride, and/or a metal organyl, preferably methyllithium, dimethylmagnesium, n-butyllithium, t-butyllithium, phenyllithium. The compounds mentioned here can be used as a solid or as a suspension in a hydrocarbon or as a solution in an essentially inert solvent.

In the further course of the after-treatment step according to the invention, the neutralization can be followed by removal of firstly the solid and subsequently the volatile constituents from the filtrate or centrifugate from step (v) to give a carbon-containing monoborosllazane, oligoborosilazane and/or polyborosilazane which has been essentially freed of residual chloride as product.

Such a treatment to reduce the chloride content of the polymer from step (v) can be carried out continuously or batchwise.

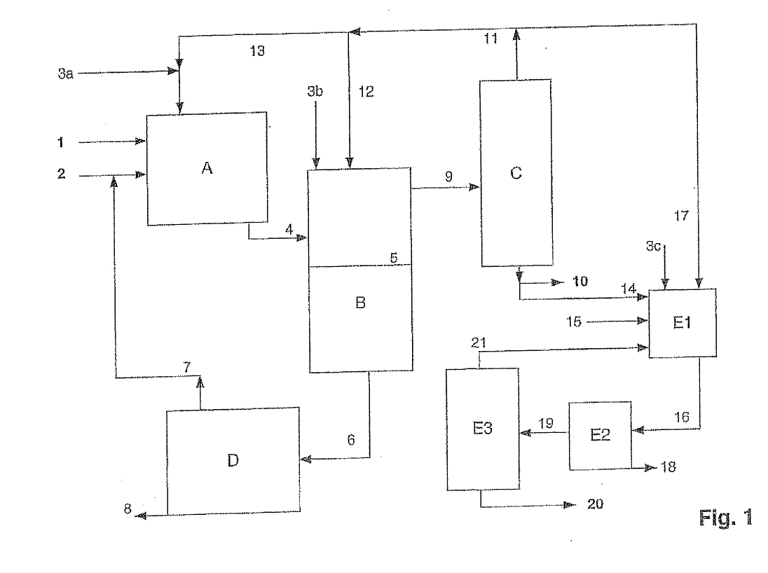

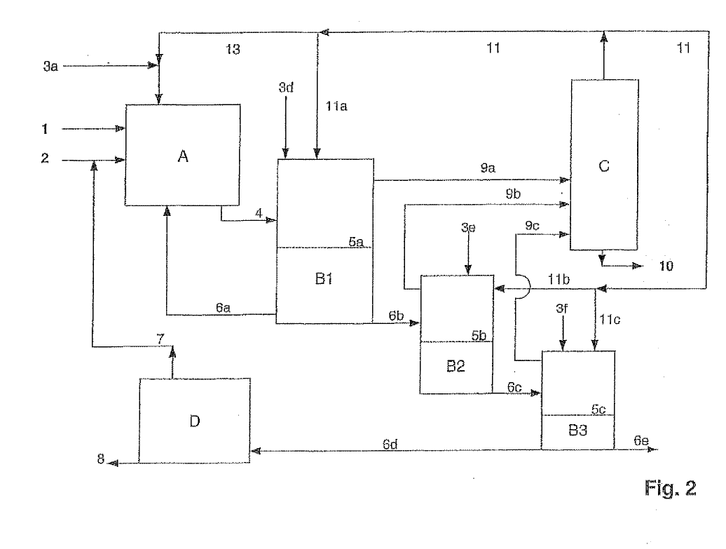

FIGS. 1 and 2 show flow diagrams of preferred embodiments of the present invention.

Thus, the present invention likewise provides an apparatus for the continuous preparation of carbon-containing polyborosilazanes which is based on
a stirred vessel (A) for carrying out the aminolysis (i) including units (1, 2) for introducing starting materials or metering-in units,
a mixing and separation unit (B) for carrying out the extraction (ii) including a unit (4) for the continuous transfer of reaction mixture from (A) to (B), a unit (9) for the continuous transfer of product dissolved in the solvent or extractant phase from (B) to (C) and a unit (6) for the discharge of the ammonia- or amine-containing phase from (B) and
a distillation unit (C) for the separation of the solvent or extractant from the product mixture including a unit (11) for the discharge of the solvent or extractant and a unit (10) via which the product is taken off.

The apparatus of the invention can advantageously comprise a unit (D) which is connected via a unit (6) to (B); in (D), solids, in particular amine hydrochloride, are separated off and discharged (8) and ammonia or organoamine can be brought into the gas phase, condensed and subsequently recirculated via unit (7), if appropriate via (2), to (A), i.e. be recycled.

In addition, the apparatus of the invention can advantageously be provided with a facility for recirculating solvent or extractant from (C) via the units (11), (12) and/or (13) to the units (A) and/or (B).

In the apparatus of the invention, it can be particularly advantageous to provide an after-treatment for polymer, cf. step (v) of the process of the invention, i.e. a purification stage (E) for removing portions of halide from a mixture of carbon-containing polyborosilazanes, with (E) being based on a dissolution and neutralization unit (E1) with feed lines for the borosilazane mixture to be purified (14), for the neutralizing agent and at least one feed line for the solvent (3c, 17, 21), a downstream unit (E2) for separating off portions of salts and, if appropriate, amine or ammonia (18) and a subsequent unit (E3) for separating off the solvent from the product stream (20).

Such an apparatus or plant can be constructed essentially from equipment and components which are known per se and are commercially available, e.g. heatable or coolable reactors or vessels, stirrers, extractions, distillation columns, filters or centrifuges, pipes, pumps or product transport equipment for liquid to viscous or solid materials and monitoring, metering, control or regulating units. The parts can be designed so as to be resistant to pressure and corrosive influences.

The present invention therefore likewise provides for the use of an apparatus according to the invention for producing a composition which comprises essentially monomeric, oligomeric and/or polymeric, carbon-containing borosilazanes and a proportion of monomeric, oligomeric and/or polymeric, halogen- and carbon-containing borosilazanes, calculated as halide, of from 0.01 ppm by weight to 0.1% by weight, preferably from 0.1 ppm by weight to 0.05% by weight, particularly preferably from 1 ppm by weight to 0.01% by weight, very particularly preferably from 10 ppm by weight to 0.005% by weight, in particular from 50 ppm by weight to 0.001% by weight.

The present invention further provides a composition which comprises essentially monomeric, oligomeric and/or polymeric, carbon-containing borosilazanes and a proportion of monomeric, oligomeric and/or polymeric, halogen- and carbon-containing borosilazanes, calculated as halide, of from 0.01 ppm by weight to 0.1% by weight.

In general, the process of the invention for obtaining polymer or particularly low-chloride polymer is carried out as follows:
The starting materials ammonia or organoamine (2) and the single-component precursor compound (1), cf. formulae Ia to Id, can be reacted in a stirred vessel or reactor (A) (aminolysis). Solvent can also be added here (3a, 13). In general, in a continuous mode of operation, reaction mixture is transferred from (A) via the transport unit (4) into the continuously operated extraction stage (B or B1) in an amount corresponding to the amount of starting material (1, 2, 3a, 13) fed in. In the extraction or the extraction stages (B or B1, B2, B3), further amounts of solvent (3b, 12 or 3d, 3e, 3f, 11a, 11b, 11c) can be fed in. The continuous extraction can have a number of stages (B1, B2, B3).

In a disengagement phase or a disengagement zone of the extraction unit (B or B1, B2, B3), a phase boundary (5 or 5a, 5b, 5c) is formed, with the upper solvent-containing phase containing the product in dissolved form. The lower phase contains excess amine or ammonia and also amine hydrochloride or ammonium chloride, at least part of which is discharged. Furthermore, an amount of the upper solvent-containing phase is transferred to the distillation unit (C) (cf. transport units 9 or 9a, 9b, 9c). Here, the amounts fed in from the extraction unit and the amounts taken off are generally balanced.

The amine- or ammonia-containing phase discharged from the extraction can be discarded. However, at least part of it can also be recirculated (6a) to (A) in order to be able to make economic use of the amine or ammonia which has been used in excess. The amine- or ammonia-containing phase can, however, also advantageously be transferred (6 or 6d), at least in part, to a work-up unit (D) where solid salts can firstly be separated off, for example by filtration (8). The filtrate can advantageously be distilled, with the overhead product advantageously being recycled (7) and salts being discharged from time to time from the bottom (8).

The solvent-containing product phase can be transferred continuously into the distillation unit (C) and there be separated into recyclable solvent (11) and polymer (10), i.e. product. The product is generally a composition comprising the monomeric, oligomeric and/or polymeric, carbon-containing borosilazanes and a still significant proportion of monomeric, oligomeric and/or polymeric, halogen- and carbon-containing borosilazanes.

To be able to provide a product composition having a very low proportion of halogen-containing polymer, it is possible, within the present process or else separately, to dissolve the polymer (10 or 14) in a solvent (E1), add a strong base (15) to neutralize or bind halide present and transfer (16) the reaction mixture to a separation unit (E2) to separate off salt formed (18). The liquid phase can then be conveyed from (E2) to (E3), viz. a distillation unit, and converted there into recyclable overhead product (21) and advantageously after-treated, particularly low-halide polymer (20). The after-treatment step can advantageously be carried out continuously.

Compositions according to the invention, i.e. polymer mixtures according to the invention having a proportion of halogen-containing polymer of less than 0.1% by weight, calculated as halide, in particular chloride (Cl⁻), can be provided comparatively simply, economically and thus advantageously by means of the continuous process of the invention using an apparatus according to the invention for further processing to produce Si/B/N/C-based products of specialty ceramics.

1. A process for preparing carbon-containing monoborosilazanes, oligoborosilazanes or polyborosilazanes comprising:
(i) reacting a single-component precursor compound with ammonia or an organic amine in an aminolysis step,
(ii) extracting reaction mixture from the aminolysis at least once with an organic solvent in a continuously operated extraction step,
(iii) discarding, working up or at least partly recirculating ammonia- or organoamine-containing phase obtained in the extraction, and
(iv) isolating carbon-containing monoborosilazanes, oligoborosilazanes or poly-borosilazanes from the solvent-containing phase from the extraction.

2. The process of claim 1, wherein said step (ii) comprises a silylaminohaloborane having a general formula Ia,
X₍₃₋ₙ₎RₙSi—(NR¹)—BRₘX′₍₂₋ₘ₎ (Ia)
where groups R are identical or different and R is a linear, branched or cyclic hydrocarbon radical having from 1 to 20 carbon atoms, R¹ is a hydrogen atom or a linear, branched or cyclic hydrocarbon radical having from 1 to 20 carbon atoms, groups X and X′ are identical or different and X and X′ are each H, F, Cl, Br, I, an alkylamino group or an alkoxy group, and n and m can, independently of one another, each be 0, 1 or 2,
a silylalkylhaloborane of the general formula Ib,
X₍₃₋ₙ₎RₙSi—[C(R⁴)₂]p-BRₘX′₍₂₋ₘ₎ (Ib)
where groups R are identical or different and R is a linear, branched or cyclic hydrocarbon radical having from 1 to 20 carbon atoms, groups R⁴ are each, independently of one another, a hydrogen atom or a linear, branched or cyclic hydrocarbon radical having from 1 to 20 carbon atoms, p can be 1, 2 or 3, groups X and X′ are identical or different and X and X′ are each X, F, Cl, Br, I, an alkylamino group or an alkoxy group, and n and m can, independently of one another, each be 0, 1 or 2,
a silylaminoborazine of the general formula Ic, 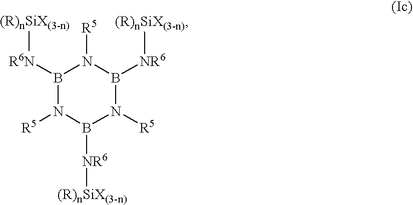
where groups R are identical or different and R is a linear, branched or cyclic hydrocarbon radical having from 1 to 20 carbon atoms, groups R⁵ and R⁶ are identical or different and R⁵ and R⁶ are each a hydrogen atom or a linear, branched or cyclic hydrocarbon radical having from 1 to 20 carbon atoms, groups X are identical or different and X is H, F, Cl, Br, I, an alkylamino group or an alkoxy group, and n can independently be 0, 1 or 2,
a silylalkylborazine of the general formula Id, 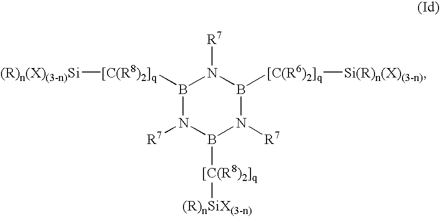
where groups R are identical or different and R is a linear, branched or cyclic hydrocarbon radical having from 1 to 20 carbon atoms, R⁷ and R⁸ are each, independently of one another, a hydrogen atom or a linear, branched or cyclic hydrocarbon radical having from 1 to 20 carbon atoms, q can independently be 1, 2 or 3, groups X are identical or different and X is H, F, Cl, Br, I, an alkylamino group or an alkoxy group, and n can independently be, 0, 1 or 2,
or a mixture thereof.

3. The process of claim 1, wherein said single-component precursor compound is selected from the group consisting of trichlorosilylaminodichloroborane, methyldichlorosilylaminodichloroborane, dimethylchlorosilylaminodichloroborane, trichlorosilylaminochloromethylborane, methyldichlorosilylaminochloromethylborane, dimethylchlorosilylaminochloromethylborane, trichlorosilyldichloroborylmethane, methyldichlorosilyldichloroborylmethane, dimethylchlorosilyldichloroborylmethane, trichlorosilylchloromethylborylmethane, methyldichlorosilylchloromethylborylmethane, dimethylchlorosilylchloromethylborylmethane, B,B′,B″-tris(trichlorosilylamino)borazine, B,B′,B″-tris[dichloro(methyl)silylamino]borazine, B,B′,B″-tris[chloro(dimethyl)silylamino]borazine, B,B′,B″-tris(trichlorosilylmethyl)borazine, B,B′,B″-tris[dichloro(methyl)silylmethyl]borazine, B,B′,B″-tris[chloro(dimethyl)silylmethyl]borazine, or a mixture thereof.

4. The process of claim 1, wherein said step (i) comprises an ammonia, a primary, or a secondary organoamine having a general formula II
R⁹_{y}NH_{(3-y)} (II),
where groups R⁹ are identical or different and R⁹ is a linear, branched or cyclic hydrocarbon radical having from 1 to 20 carbon atoms, and y can be 1 or 2,
or a mixture thereof.

5. The process of claim 4, wherein said ammonia, a primary or secondary organoamine is selected from the group consisting of methylamine, ethylamine, dimethylamine diethylamine, and a mixture thereof.

6. The process of claim 5, wherein said aminolysis step (i) comprises an excess amount of ammonia or organoamine.

7. The process of claim 1, wherein said aminolysis step (i) is carried out at a temperature in a range from −50 to +80° C. and a pressure of from 0.1 to 40 bar abs.

8. The process of claim 1, wherein said aminolysis step (i) is carried out in a single phase.

9. The process of claim 1, wherein said aminolysis step (i) is carried out in the presence of a solvent.

10. The process of claim 9, where said solvent comprises a substance or a mixture thereof, said substances selected from the group consisting of C₃-C₉-hydrocarbons.

11. The process of claim 1, wherein said aminolysis step (i) is carried out continuously, with starting materials being fed to the reaction mixture in an amount corresponding to the amount of reaction mixture being taken off from step (i) and fed to step (ii).

12. The process of claim 1, wherein said organic solvent in said extracting step (ii) comprises a substance or a mixture thereof, selected from the group consisting of C₃-C₉-hydrocarbons.

13. The process of claim 12, wherein said solvent is selected from the group consisting of n-butane, i-butane, n-pentane, i-pentane, n-hexane, cyclohexane, n-octane, i-octane, petroleum spirit, toluene, xylene, or a mixture thereof.

14. The process of claim l, wherein a ratio of said solvent to said ammonia or organoamine in said extraction step (ii) is 20:1 v/v to 1:20 v/v.

15. The process of claim 1, wherein the extraction step (ii) is operated at a temperature in a range from −50° C. to a boiling point of the solvent or organoamine used.

16. The process of claim 1, wherein the extraction mixture is separated into a solvent-containing phase and an ammonia- or organoamine-containing phase said extraction step (ii).

17. The process of claim 16, wherein the ammonia- or organoamine-containing phase separated off in a preceding extraction stage is extracted once more with a solvent.

18. The process of claim 1, wherein the extraction step (ii) comprises at least one to six extraction stage(s).

19. The process of claim 1, wherein at least part of the ammonia- or organoamine-containing phase in step (iii) is recirculated to the aminolysis step (i), or distilled, and the organoamine or ammonia recovered in this way is reused.

20. The process of claim 1, wherein the solvent is separated by distillation from the solvent-containing phase in step (iv), purified and recirculated to the aminolysis step (i) and/of or the extraction (ii), and the carbon-containing borosilazane obtained is after-treated.

21. The process of claim 20, wherein the carbon-containing borosilazane comprising monomeric, oligomeric or polymeric borosilazane is dissolved in a solvent and a strong base is added to this solution; or, wherein the solvent-containing phase forms a (crystalline) chloride under prevailing conditions, said crystalline chloride salt is separated from a liquid, solvent- or extractant-containing phase and the with a treatment step is repeated one or more times.

22. The process of claim 21, wherein said strong base comprises ammonia, a primary or secondary organoamine, a metal amide, metal hydride and a metal organyl.

23. The process of claim 22, wherein solid and subsequently the volatile constituents are further removed by filtration or centrifugation, and carbon-containing monomeric, oligomeric or polymeric borosilazane which is essentially freed of residual chloride is obtained as product.

24. The process of claim 1, wherein said step (v) is carried out continuously or batchwise.

25. An apparatus for a continuous preparation of carbon-containing monoborosilazanes, oligo-borosilazanes or polyborosilazanes comprising:
a stirred vessel (A) for carrying out an aminolysis step (i) including units (1, 2) for introducing or starting materials or metering-in units,
a mixing and separation unit (B) for carrying out an extraction step (ii) including a unit (4) for a continuous transferring a reaction mixture from (A) to (B), a unit (9) for a continuous transferring product dissolved in a solvent phase from (B) to a distillation unit (C) and a unit (6) for discharging an ammonia- or amine-containing phase from (B), and
a distillation unit (C) for separating the solvent from a product mixture including a unit (11) for discharging the solvent and a unit (10) where the product is taken off.

26. The apparatus of claim 25, wherein in said unit (D) which is connected via a unit (6) to (B), solids are separated off and discharged (8) and ammonia or organoamine are brought into a gas phase, condensed and subsequently recirculated via unit (7), via (2), to (A).

27. The apparatus of claim 25 further comprising a facility for recirculating solvent from (C) via the units (11), (12) or (13) to the units (A) or (B).

28. The apparatus of claim 25 further comprising a purification stage (E) for removing portions of halide from a mixture of carbon-containing monoborosilazanes, oligoborosilazanes or polyborosilazanes, said purification stage (E) comprising a dissolution and neutralization unit (E1) comprising feed lines for purifying borosilazane mixture (14), a neutralizing agent, and at least one feed line for the solvent (3c, 17, 21), a downstream unit (E2) for separating salts and portions of amine or ammonia (18), and a subsequent unit (E3) for separating the solvent from a product stream (20).

29. A method of use of the apparatus of claim 25 for producing a composition which comprises essentially monomeric, oligomeric or polymeric, carbon-containing borosilazanes, or a proportion of monomeric, oligomeric or polymeric, halogen- and carbon-containing borosilazanes, calculated as halide, of from 0.01 ppm by weight to 0.1% by weight.

30. A composition comprising essentially monomeric, oligomeric or polymeric, carbon-containing borosilazanes, or a proportion of monomeric, oligomeric or polymeric, halogen- and carbon-containing borosilazanes, calculated as halide, of from 0.01 ppm by weight to 0.1% by weight.
